(19) United States
(12) Patent Application Publication
(10) Pub. No.: US 2006/0096814 A1
(43) Pub. Date: May 11, 2006

(54) Chassis subassembly for motor vehicles

(76) Inventors: Wolfgang Hoffrichter, Koln (DE); Jorg Brecht, Olpe (DE); Carsten Fiedler, Berlin (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/512,722

(22) PCT Filed: Apr. 17, 2003
(86) PCT No.: PCT/EP03/04052

§ 371 Date: Sep. 1, 2005

(30) Foreign Application Priority Data
Apr. 26, 2002 (DE) 102 18 907.2

(51) Int. Cl. F16D 65/38

(52) U.S. Cl. 188/73.37

(57) ABSTRACT

Disclosed is a subassembly comprising a braking system which generates friction-induced vibrations. At least one component of the subassembly is exposed to the friction-induced vibrations. Said component can be embodied as a brake pad (9) which is provided with a support plate (5) and a friction lining (10). The support plate (5) and the friction lining (10) form two hollow spaces which are filled with fillings (2) made of energy-absorbing material and are covered by a damping metal sheet (7). The fillings (2) dissipate vibration energy when the brake lining vibrates, thereby contributing to preventing disturbing braking noise from being generated.

The invention relates to a chassis assembly for motor vehicles, with a braking system which generates friction-induced vibrations and with at least one component which is subjected to the friction-induced vibrations.

Vibrations of machines and drives or of the components thereof are often undesirable. This applies in particular to friction-induced vibrations which occur in a very wide frequency range from approximately 300 Hz to 15000 Hz and thereby lead to very loud and disturbing squeaking noises. These squeaking noises are particularly noticeable and troublesome in the case of motor vehicle brakes.

Primary and secondary countermeasures are known. The primary countermeasures attempt to shift the natural frequency of the system by the use of additional masses or to absorb the vibration of the components by phase-shifted vibrations by way of resiliently mounted shock-absorbing masses. Both these measures are only effective in a narrow frequency band, and outside this frequency band they can even lead to an intensification of the vibrations. Within the brakes and clutches sector the secondary measures include so-called damping sheets, damping films or damping paints which are applied to the friction lining support plate and are disposed in such a way that they have a damping or decoupling effect between the support plate and its supports. Since they lie in the line of action of force and accordingly are subjected to high load forces, damage can occur at an early stage which leads to restriction of functioning.

It is not only the components of the actual braking system, such as for instance the brake disc or brake drum, brake calliper, brake lining, piston etc., which can be subjected to the friction-induced vibrations, but also adjacent chassis components such as for instance the strut, anti-spray guard plate, inner lining of the wheel case, axle parts, etc.

The object of the invention is to make possible a simple and reliable reduction or avoidance of vibration of components.

In order to achieve this object, according to the invention the assembly referred to in the introduction is characterised in that a cavity containing an energy-absorbing filling is associated with the component which is exposed to the friction-induced vibrations.

The filling is set in vibrational movement independently of the frequency and dissipates the vibrational energy introduced into the component by internal friction. The arrangement can be such that any mechanical stresses acting on the component cannot restrict the function of the energy-absorbing filling. The cavity is preferably disposed in the vicinity of high amplitudes of movement of the vibration modes to be damped.

The energy-absorbing filling of the cavity preferably comprises a particulate material, particularly sand, blasting material, glass powder, casting powder, plastics particles or the like. As an alternative a viscoelastic fluid or a pasty medium may be considered. In both cases it is advantageous that the energy-absorbing filling contains at least one solid body which is movable in the filling and which by its movements assists the dissipative energy absorption of the filling.

A further equally advantageous possibility resides in the fact that the energy-absorbing filling comprises a resilient material, for example rubber or cork, containing at least one solid body.

In each case the solid body does not have to be rigid; it can also be deformable.

Advantageously the energy-absorbing filling should at least largely fill the cavity.

In a significant further development of the invention it is proposed that the cavity is disposed at least in part in the component. Alternatively or additionally the possibility exists that the cavity is formed at least in part by a container which is disposed on the component. The component can be fixed permanently on the container for example by adhesion, pressing in, pressing on, riveting, welding, extrusion, rolling in, casting on, etc., or can also be fixed releasably thereon by insertion or screwing.

The principal field of application of the invention is brake and clutch technology, particularly brake technology. Therefore in a further development of the invention it is proposed that the cavity is associated with a brake lining or clutch lining having a support plate and a friction lining.

In this connection there are numerous possibilities for transferring the concept according to the invention.

Thus the cavity can be formed by a sandwich damping sheet which is adhered to the support plate. The damping sheet filled with the energy-absorbing material is preferably only disposed on those regions of the support plate into which no forces are introduced.

Furthermore the support plate can be provided with additional plug holes into which cups filled with the energy-absorbing material are pressed after completion of the brake lining or clutch lining. In order to keep the additional plug holes free of friction material during the production of the brake lining or clutch lining the reflex plate has corresponding rams.

The support plate can be provided with circular or groove-shaped depressions which are filled with the energy-absorbing material after pressing of the friction material. For sealing, a single damping sheet is adhered or, if a sandwich support plate is involved, the second sheet of the sandwich plate is adhered.

Cups which are filled with the energy-absorbing material can also be screwed to the support plate using the “Nelson process”.

When the damping sheet/piston spring is wobbled a cup filled with the energy-absorbing material and then closed with a cover can be wobbled therewith.

It is also possible to provide a damping sheet with at least one cup by deep-drawing. After filling of the cup the damping sheet is adhered to the support plate.

A particularly advantageous embodiment resides in the fact that the cavity is disposed at least in part in the friction lining. The energy-absorbing filling can then assume the function of a wear indicator, above all by producing an acoustic effect after corresponding wear of the friction lining.

If the cavity is to be disposed completely in the friction lining, then by means of a ram a depression is made in the previously compressed friction material and the energy-absorbing filling is introduced into this depression either as a powder or filling into PE bags. Then the brake lining or clutch lining is pressed and hardened as usual.

As an alternative it is possible to provide the support plate with at least one additional plug hole which is protected against the ingress of friction material by a ram of the reflex plate during the production of the brake lining or clutch lining. Then the friction material is drilled in an extension of the plug hole, the resulting cavity is filled with energy-absorbing material and is closed by adhesion of a damping sheet or a sheet forming part of the support plate.

Instead of drilling the friction material the depression can also be produced by a correspondingly lengthened ram of the reflex plate.

The invention will be explained in greater detail below with reference to preferred embodiments in connection with the appended drawings, in which:

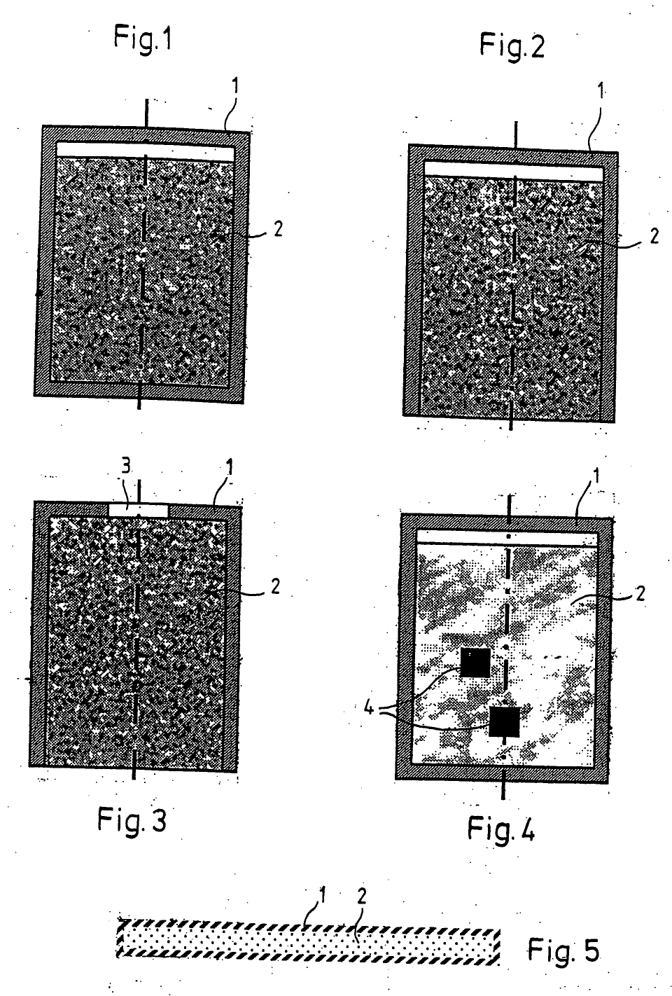

FIGS. 1 to 5 show various containers containing an energy-absorbing filling;

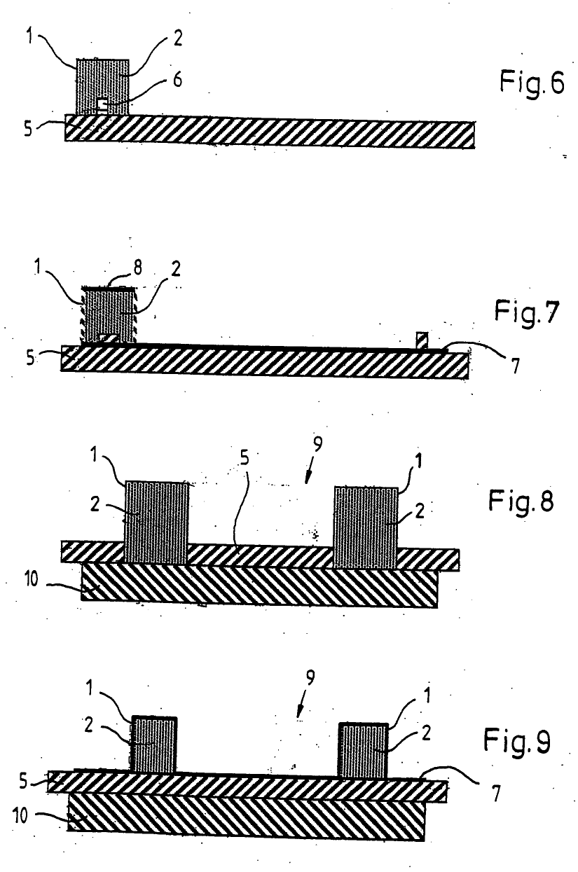

FIGS. 6 to 9 show various possible container fixing means;

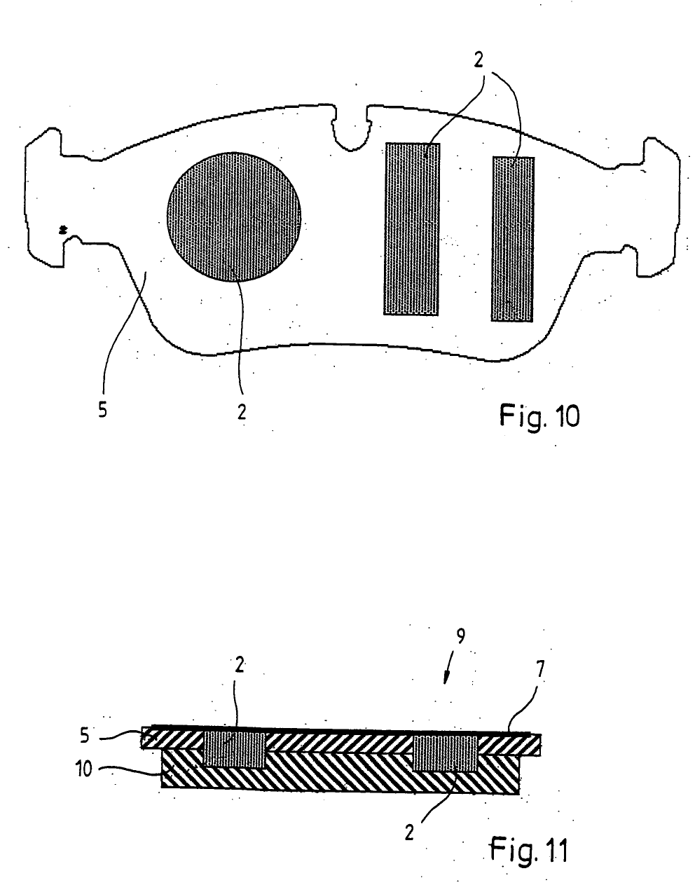

FIG. 10 shows a plan view of a support plate;

FIG. 11 shows a section through a brake lining.

FIG. 1 shows a container 1 which contains a filling 2 of energy-absorbing material. The filling 2 comprises a particulate material, namely blasting material, which almost completely fills the container 1.

The container 1 according to FIG. 2 differs from hat of FIG. 1 only in that its base is open.

The same applies to the container 1 according to FIG. 3. Apart from this, the container 1 has in its cover an opening 3 which is intended for the passage of a screw for screwing it to the component. Furthermore the filling 2 here takes up the entire interior of the container 1.

In the container 1 according to FIG. 4 the filling 2 does not comprise powdered material but a viscoelastic fluid containing two solid bodies 4. As soon as the associated component is set in vibration, the two solid bodies can move within the fluid and thus contribute to the dissipation of the vibrational energy.

As already stated above, a large number of other materials may be considered for the filling 2. In each case solid bodies 4 may be contained in the filling 2.

According to FIG. 5 the container 1 forms a sandwich damping sheet for a brake lining.

FIG. 6 shows the fixing of the container 1 on a support plate 5 of a brake lining. A screw 6 is connected to the support plate 5 using the “Nelson process”. The container 1 is screwed onto this.

The fixing according to FIG. 7 differs from this type of fixing in that when a damping sheet 7 is wobbled the container 1 wobbles with it. The container 1 is open at the top and after filling it is closed by means of a cover 8.

FIG. 8 shows a brake lining 9, the support plate 5 of which is provided with a friction lining 10. The support plate 5 has two openings into which the containers 1 are pressed.

According to FIG. 9 the containers 1 are formed by the damping sheet 7. For this purpose the damping sheet 7 has corresponding deep-drawn cups.

According to FIG. 10 the support plate 5 is provide with depressions which serve to receive the fillings 2. The material of the fillings 2 can be put into small sausage-shaped bags. It can also be contained in a binder, e.g. wax, which breaks down upon hardening. The material is pressed into the depressions, whereupon the friction lining is pressed on.

In the brake lining 9 according to FIG. 11 the support plate 5 is provided with two openings in a similar manner to the embodiment according to FIG. 8. When the friction lining is pressed on these openings are kept free of friction material by corresponding rams of the reflex plate. Unlike the embodiment according to FIG. 8, in the brake lining 9 according to FIG. 11 these rams project into the friction material. Thus the fillings can extend into the friction material. The adhered damping sheet 7 seals the openings. The great advantage of this embodiment resides in the fact that the fillings simultaneously fulfil the function of a wear indicator.

The openings which extend into the friction material can also be drilled out.

It goes without saying that an underlayer can be disposed between the support plate and the friction lining.

1-12. (canceled)

13. Chassis assembly for motor vehicles having a braking system which generates friction-induced vibrations, and at least one component which is subjected to the friction-induced vibrations, said at least one component comprising at least one cavity containing an energy-absorbing filling, the filling being set in vibrational movement independently of the frequency and dissipating the vibrational energy introduced into the component by internal friction, said energy-absorbing filling of the cavity comprising a particulate material, a viscoelastic fluid or a pasty medium, and wherein the energy-absorbing filling contains at least one solid body which is freely movable in the filling.

14. Assembly as claimed in claim 13, wherein the particulate material comprises sand, blasting material, glass powder, casting powder, plastics particles or the like.

15. Assembly as claimed in claim 13, wherein the solid body is deformable.

16. Assembly as claimed in claim 13, wherein the energy-absorbing filling at least largely fills the cavity.

17. Assembly as claimed in claim 13, wherein the cavity is disposed at least in part within the component.

18. Assembly as claimed in claim 13, wherein the cavity is formed at least in part by a container which is attached to the component.

19. Assembly as claimed in claim 13, wherein the cavity is associated with a brake lining or clutch lining having a support plate and a friction lining.

20. Assembly as claimed in claim 19, wherein the cavity is disposed at least in part within the friction lining.

21. Chassis assembly for motor vehicles having a braking system which generates friction-induced vibrations, and at least one component which is subjected to the friction-induced vibrations, said at least one component comprising at least one cavity containing an energy-absorbing filling, the filling being set in vibrational movement independently of the frequency and dissipating the vibrational energy introduced into the component by internal friction, said energy-absorbing filling comprising a resilient material and least one free solid body.

22. Assembly as claimed in claim 21, wherein the solid body is deformable.

23. Assembly as claimed in claim 21, wherein the energy-absorbing filling at least largely fills the cavity.

24. Assembly as claimed in claim 21, wherein the cavity is disposed at least in part within the component.

25. Assembly as claimed in claim 21, wherein the cavity is formed at least in part by a container which is attached to the component.

26. Assembly as claimed in claim 21, wherein the cavity is associated with a brake lining or clutch lining having a support plate and a friction lining.

27. Assembly as claimed in claim 26, wherein the cavity is disposed at least in part within the friction lining.
